(19) United States
(12) Patent Application Publication
(10) Pub. No.: US 2014/0091511 A1
(43) Pub. Date: Apr. 3, 2014

(54) Apparatus for Manipulating Substrates

(71) Applicant: Sean Martin, Watkins, CO (US)

(72) Inventor: Sean Martin, Watkins, CO (US)

(21) Appl. No.: 13/970,589

(22) Filed: Aug. 19, 2013

Related U.S. Application Data
(60) Provisional application No. 61/684,713, filed on Aug. 18, 2012.

(51) Int. Cl. B23Q 3/18

(52) U.S. Cl. CPC B23Q 3/18
USPC 269/289 R

(57) ABSTRACT

The invention refines the standard cutting tool concept used in substrate manipulation systems, such as CNC applications. Aspects of the invention provide a novel substrate manipulation attachment that provides superior functionality and lower operating costs by utilizing standard utility knife blades and other off-the-shelf components.

### CROSS REFERENCE TO RELATED APPLICATION

The present application claims the benefits of U.S. Provisional Application Ser. No. 61/684713, filed on Aug. 18, 2012, and entitled “Drag Knife Cutting Tool for Cutting Substrates with CNC Machines” and which is incorporated herein in its entirety.

### FIELD

The invention generally relates to the field of machining, and in particular the use of a tool attachment in a substrate manipulation system such as a multiaxis or CNC machining system.

### BACKGROUND

Multiaxis and CNC machining systems utilize computer numerically controlled tools to cut, mill, or otherwise manipulate substrate material. Typical machining systems support translation in three axes. Multiaxis machines can support rotation around one or multiple axes, with five axis systems becoming more common. Software systems allow for programming of a machining operation, and guide the tools through a series of operations to manipulate the substrate material.

Common machining tools are used for cutting, shaping, milling, or otherwise manipulating the substrate material. Machining tools generally comprise an attachment to complete the cutting and other manipulation operations.

A commonly used tool is a drag knife. Drag knives are used in particular for cutting thin substrates such as vinyl. A drag knife is a device which utilizes friction with the material it is cutting to orient itself during manipulation of the substrate. The tool is mounted in a freely rotating holder. The tool further comprises a cutting device, such as a blade, for substrate manipulation. Typically the tip of the blade is slightly off center with respect to the axis of rotation. As the tool is moved across the substrate material, the tip of the blade drags behind the tool, and maintains proper orientation.

Typical constructions for such a device involve a holder which houses ball bearings. The blade can then be mounted directly into the ball bearings in a mounting device that freely rotates within the ball bearings. Knife blades ground from round stock are not readily available and therefore cost more. Traditional drag knifes therefore involve a less expensive device, but more expensive blades. Moreover, currently available drag knives do not cut substrate thicker than 0.010 inch in thickness.

A solution therefore is required to cut thicker substrate, and to provide a lower operating cost for substrate manipulation than presently available. Novel embodiments of the invention solve these problems and offer desired performance at a lower long-term operating cost. Although embodiments of the invention may require a somewhat larger initial investment, they offer a dramatically reduced long term cost of operating the device.

### SUMMARY

These and other needs are addressed by the various aspects, embodiments, and configurations of the present disclosure. The aspects, embodiments, and configurations are directed generally to an apparatus for manipulating substrates in a substrate manipulation system.

In one aspect, the apparatus comprises the following:
(a) an attachment end;
(b) a bearing holder, wherein the bearing holder comprises a plurality of bearings;
(c) a mount holder, comprising a mounting surface; and
(d) wherein a substrate manipulation attachment may be mounted to the mounting surface.

In another aspect, the apparatus further comprises an alignment mechanism. The substrate manipulation attachment may be attached to the alignment mechanism. The alignment mechanism may be adjustable, to accommodate a wide range of angles at which the substrate manipulation attachment contacts the substrate. The substrate manipulation attachment may be secured with at least one of a clamp and a fastener.

In other aspects, the substrate manipulation attachment is a utility knife blade. The substrate manipulation attachment also may be a creasing attachment, a rotary cutter, or a glass cutting tool. In these embodiments, the substrate manipulation attachment can easily be changed, at low cost, when it is worn.

In other aspects, the substrate manipulation attachment is incorporated into the mount holder, so the entire apparatus is comprised of as little as one machined piece.

In another aspect, the apparatus is used in a substrate manipulation system and comprises the following:
(a) an attachment end; wherein the attachment end attaches the apparatus to a substrate manipulation system;
(b) a bearing holder, wherein the bearing holder comprises a plurality of bearings;
(c) a mount holder, comprising a mounting surface; and
(d) wherein a substrate manipulation attachment may be mounted to the mounting surface.

In another aspect, substrate manipulation system is a CNC machining system. The substrate manipulation system also may be a multiaxis machining system, or a five axis machining system. In these embodiments, the apparatus may be used to form complex manipulations of substrates in computer numerically controlled systems.

These and other advantages will be apparent from the disclosure of the aspects, embodiments, and configurations contained herein

The “system” or “substrate manipulation system” can be any of a CNC machine, a CNC plotter, a vinyl cutting system, any cutting system plotter, or any plotting system using a cutting tool or other substrate manipulation attachment.

“Substrate” means any material used in the system , whether cut, punctured, folded, creased, torn or otherwise manipulated from its baseline condition. A substrate may be wood, vinyl, paper, cardboard, fabric, plastic, polymer, glass, metal or any other material.

“Cutting tool” can include any of a knife, blade, razor, or other sharp cutting tool. Additionally, the cutting tool concept can include a flat surface, blade, folding tool, or other system designed to crease, bend, or otherwise partially or substantially break the surface of the substrate. The latter can occur with or without making a complete penetration of the substrate.

### BRIEF DESCRIPTION OF THE DRAWINGS

FIG. 1 is a depiction of a preferred embodiment of the apparatus.

FIG. 2 is a depiction of an embodiment of the apparatus.

### DETAILED DESCRIPTION

The invention presents a novel tool attachment for use in substrate manipulation systems. The tool attachment typically is made of a machined metal stock. The tool attachment has an attachment end such that it can be mounted in the machining system. The tool attachment additionally contains a mounting surface. The mounting surface can be a flush mounting surface and, optionally, can be adjustable to vary the mounting angle. A substrate manipulation attachment attaches to the mounting surface. The substrate manipulation attachment is used to manipulate the substrate when the substrate manipulation system operates.

In a preferred embodiment, the invention produces a drag knife that uses a standard off the shelf utility knife blade. Such blades are readily available and can be purchased at any hardware store or home center. This type of blade has been highly refined and developed to cut a wide variety of materials. Utilizing such a blade in a drag knife capitalizes on this refinement making it possible to cut a wider variety of materials and substrates than permitted by previous drag knife designs. Additionally, use of an inexpensive, easily replaceable blade lowers the operating cost of the cutting tool.

The drag knife contemplated by the invention is designed to be installed in an xyz position machine, but is most commonly used in CNC router systems. The device can be mounted directly in a router or spindle collet. Such a mount makes it very simple for any CNC user to install it in their machine and use it without any modifications to their device. It can also be mounted as a stand alone device without the use of the collet or spindle should the user have the need. In a preferred embodiment, the invention is made from machined aluminum, although any appropriate metal may be utilized for the invention.

The device consists of body, or bearing holder, which houses bearings, preferably ball bearings. The bearing holder is attached to a mount holder that comprises a mounting surface. A fastener holds the utility knife blade in position. The bearings allow the mount holder to freely rotate within the bearing holder. The bearing holder can be mounted in a collet or directly to the zxy positing system. The tool attachment fits into a CNC router or spindle collet, making it a universal fit for commonly available CNC routers. The tool attachment may be designed to use a utility knife blade or other off the shelf cutting tool. By utilizing off the shelf disposable components, the invention dramatically reduces cost relative to standard consumable cutting tools.

In operation, the tip of the cutting tool trails behind the motion of the CNC. The precision bearings in the tool allow it to freely rotate and act much like the castor on an office chair. Sharp corners are achieved with what are referred to as corner actions within the CNC tool path. These corner actions instruct the CNC to raise the blade such that the tip is just barely in contact with the material surface. The machine then moves through a very small circle around the tip of the blade causing the blade to rotate, while the tip of the blade remains in the same location. The machine then moves the blade back to the cutting depth and resumes cutting.

In preferred embodiments, the substrate manipulation system typically is a standard CNC machining system or a commonly available plotting system. Typically, no special software is required. The invention also can operate with specialized software systems to create sharp corners that are not readily created with available systems. Optimum use of the invention, including sharp corner cuts in the substrate can be recognized with commercial software. Options include SheetCAM, Vectric VCarve Pro 7, or Vectric Aspire 4. All of these CAM packages offer drag knife tool path capabilities with specialized corner actions, and will enable the operator to capture the full functionality of the tool.

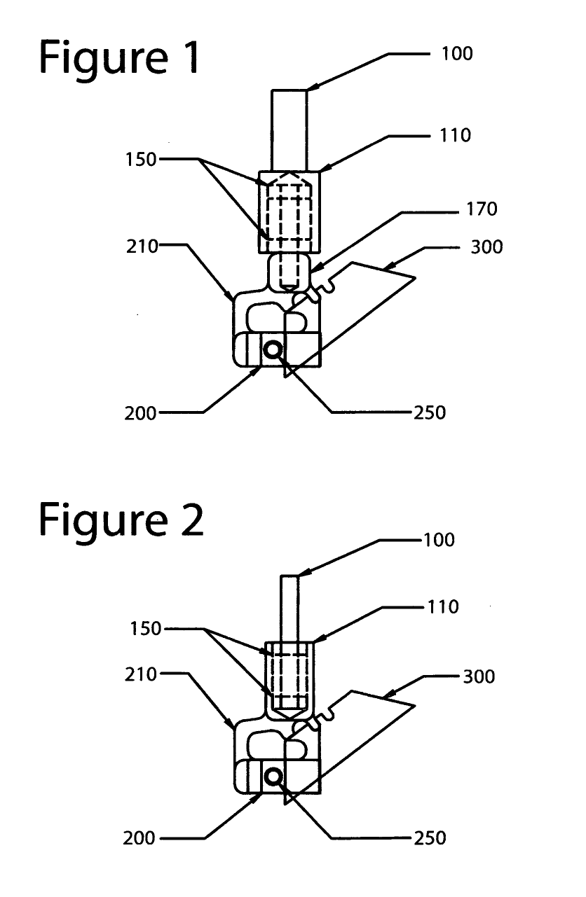

The concept is more fully appreciated by viewing drawings of a preferred embodiment. A representative copy of an embodiment is shown in FIG. 1. The embodiment comprises an attachment end 100. The attachment end 100 may be designed to mount the tool attachment into any of the standard substrate manipulation systems described herein or otherwise known in the art. Preferably the attachment end is designed to fit into standard ¼ inch and ½ inch collets.

The present embodiment further comprises a bearing holder 110, attached to the attachment end 100. The bearing holder 110 houses a plurality of bearings 150. Preferably the bearings 150 are ball bearings. When the tool is utilized in a substrate manipulation system, the ball bearings 150 allow the tool to rotate freely and the substrate manipulation attachment 300 to manipulate substrate in linear or nonlinear patterns.

The substrate manipulation attachment 300 is mounted to the mount holder 210. The mount holder 210 has a mounting surface, to which the substrate manipulation attachment 300 is secured by a clamp 200. The clamp is secured by a fastener 250, which preferably is a screw or other easily adjustable fastener. The mounting surface can optionally be relocated to other convenient locations on the mount holder 210, depending on the specific embodiment. In some embodiments, the mounting surface can be adjusted to provide for mounting the substrate manipulation attachment 300 at different mounting angles. In still other embodiments, the mounting surface can be adjusted while the tool attachment is in operation, to allow for varying the angle of the substrate manipulation attachment 300 during operation.

In the present embodiment, the substrate manipulation attachment 300 is additionally attached to an optional alignment mechanism 170. The alignment mechanism 170 attaches to the bearing holder 110 and the mount holder 210. The alignment mechanism 170 is configured with geometry features to align the substrate manipulation attachment 300. As shown, the geometry features mate with the substrate manipulation attachment 300 and provide a rigid second attachment point, in addition to the mounting surface of the mount holder 210. Optionally, the alignment mechanism 170 can be adjustable, to vary the angle at which the substrate manipulation attachment 300 is contacted with a substrate.

FIG. 2 shows an embodiment in which the aligning features of the alignment mechanism 170 are incorporated into the bearing holder 110. This embodiment features reduced complexity by elimination of the alignment mechanism 170. The substrate manipulation attachment 300 is held in alignment by an appropriate geometry feature as incorporated into the bearing holder 110.

As depicted, the substrate manipulation attachment 300 is a standard utility blade readily available for many consumer applications. An important feature of the invention is to use low cost, disposable substrate manipulation attachments that can be easily replaced as they wear. This makes the embodiments of the invention cost effective alternatives to replacing expensive standard machining tools. In the drag knife concept depicted, operation of the tool attachment should be apparent to one of skill in the art. When a CNC machine is utilized for the substrate manipulation system, the knife traces out a cutting pattern as programmed into the machine. The ball bearing assembly allows the knife to swivel and trace complex patterns. The utility blade knife can be set to cut a range of thicknesses and materials.

Of course, the application shown is non-limiting in nature, and the invention should be read to cover a range of embodiments incorporating similar components and functions. It should further be recognized that other substrate manipulation attachments could be incorporated into the invention to serve a wide range of substrate manipulation needs.

The following additional embodiments of the invention are provided for purposes of demonstrating the scope of the invention. These embodiments are non-limiting in nature and are intended to show the range of uses contemplated by the invention.

In an embodiment, the tool attachment comprises an adjustable flush mounting system that allows for the blade angle to adjust. Typically a cutting tool comes with a fixed blade angle. If the operator desires a different type of cut with a different blade angle, a different tool is required. Such embodiments contemplate an adjustable mounting surface, wherein the blade is mounted firmly to the mounting surface. The mounting surface then can be adjusted and set to the preferred angle. The tool therefore allows multiple blade setting angles, reducing the need for different tools for each desired blade angle. The system can be adjusted manually with a fastener system. In other embodiments, the blade can be adjusted during use, through an electrical adjustment system, or a spring loaded system.

In another embodiment, the tool attachment contains an angled mounting surface. The angled mounting surface can incorporate any of the included mounting systems. The angled mounting surface allows the blade to make angled cuts, relative to the depth of the substrate. For example, the top surface of the substrate will have an offset relative to the bottom surface of the substrate after the cut is made. Thus, when the substrate manipulation attachment is mounted to the angled mounting block, it creates angled cuts in the substrate, and creates angled surfaces.

The angled mounting block can be set to preferred angles such as 30, 45, or 60 degrees. Optionally, the angled mounting block has an adjustable mounting system so the angle can be changed to any preferred cut angle. The adjustable mounting system may be designed so it can be adjusted during operation. An exemplary use of this embodiment is to create angled cuts for cutting photo matting. Of course, the system could be sized and scaled and applied similarly in a wide range of applications.

In another embodiment, the tool attachment also can be used to manipulate substrate without a cutting tool. For example, the blade or cutting attachment used in the preferred embodiment can be replaced with a creasing attachment. Optionally, the creasing attachment can be incorporated directly into the tool attachment, and permanently fixed to the mounting surface. In an embodiment, the tool does not make a complete cut through the substrate. Instead, the creasing tool is used to crease or indent the surface of the substrate. Preferred substrates for this use include cardboard or corrugated material. The creasing tool presses the surface of the substrate, creating a crease or indent. The substrate then can be folded, bent, or otherwise manipulated along the manipulated surface. In some embodiments, the creasing tool may puncture or tear the surface of the material, but will not completely tear through the bottom surface of the material.

Representative embodiments include pressing seems along sheets of cardboard. The cardboard then can be folded into boxes, with the folding lines identified by the creases created from the creasing attachment.

In still other embodiments, the invention incorporates an oscillating blade. The oscillating cutting blade can be used to cut thicker materials. In variations of this aspect, the cutting blade can be used to cut varying depths in the substrate.

### Experimental

Embodiments of the invention have established it has many practical applications. Applied in a drag knife application, embodiments have been used in a CNC router to cut snowboard and ski base materials, wood veneer for inlay/marquetry artwork, leather, carbon fiber pre-preg laminates for aerospace, military, and automotive components, cardboard for custom packaging, and much more. Generally, the tool attachment can be used with any substrate that can be manipulated in a substrate manipulation system. In the drag knife embodiment, the system can be used to cut almost anything you would cut with a utility knife, but with the speed and precision of a CNC router.

The following materials have been cut utilizing the drag knife razor blade embodiment: plastics, including UHMW polyethylene, ABS, lexan film; cardboard, including corrugated and paperboard; Coroplast (corrugated plastic sign material); vinyl, including sign and sticker vinyl; all kinds of paper; foam, including foamboard such as RL Adams Rediboard; wood veneer; pre-preg carbon fiber laminates; leather, both thin and thick materials; fabric, which can be cut, but the best results come with the creasing attachment and a rotary cutter.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

I claim the following:

1. An apparatus for manipulating a substrate comprising:
an attachment end;
a bearing holder, wherein the bearing holder comprises a plurality of bearings;
a mount holder, comprising a mounting surface; and
wherein a substrate manipulation attachment may be mounted to the mounting surface.

2. The apparatus of claim 1, further comprising an alignment mechanism.

3. The apparatus of claim 2, wherein the substrate manipulation attachment is attached to the alignment mechanism.

4. The apparatus of claim 2, wherein the alignment mechanism is adjustable.

5. The apparatus of claim 1, wherein the mounting surface is adjustable.

6. The apparatus of claim 1, wherein the substrate manipulation attachment is secured with at least one of a clamp and a fastener.

7. The apparatus of claim 1, wherein the substrate manipulation attachment is incorporated into the mount holder.

8. The apparatus of claim 1, wherein the substrate manipulation attachment is a utility knife blade.

9. The apparatus of claim 1, wherein the substrate manipulation attachment is a creasing attachment.

10. The apparatus of claim 1, wherein the substrate manipulation attachment is a rotary cutter.

11. The apparatus of claim 1, wherein the substrate manipulation attachment is a glass cutting tool.

12. An apparatus for manipulating a substrate in a substrate manipulation system, comprising:
an attachment end, wherein the attachment end attaches the apparatus to a substrate manipulation system;
a bearing holder, wherein the bearing holder comprises a plurality of bearings;
a mount holder, comprising a mounting surface; and
wherein a substrate manipulation attachment may be mounted to the mounting surface.

13. The apparatus of claim 12, wherein the substrate manipulation system is a CNC machining system.

14. The apparatus of claim 12, wherein the substrate manipulation system is a multiaxis machining system.

15. The apparatus of claim 12, wherein the substrate manipulation system is a five axis machining system.
